(19) United States
(12) Patent Application Publication
(10) Pub. No.: US 2006/0103103 A1
(43) Pub. Date: May 18, 2006

(54) Lightweight, low part-count, suspension system for wheeled vehicles

(76) Inventors: Jonathan L. Land, Flower Mound, TX (US); Donald S. Winn, Corinth, TX (US); Eric M. Schneck, Burlington, VT (US); David L. Van Duker, Camano Island, WA (US); David B. Ford, Denton, TX (US)

Correspondence Address: SIDLEY AUSTIN LLP, 717 NORTH HARWOOD, SUITE 3400, DALLAS, TX, 75201, US

(21) Appl. No.: 10/988,140

(22) Filed: Nov. 12, 2004

(51) Int. Cl. B60G 11/46; F16F 1/26

(52) U.S. Cl. 280/124.163; 280/124.165; 280/124.175; 267/260

(57) ABSTRACT

A low part count, light weight, low-rise air leaf suspension system is provided. One end of the leaf spring has a formed eye pivotally mounted by a pin to a lightweight bracket mounted to the vehicle frame. The leaf spring is tapered toward the ends to reduce weight. Light weight clamping blocks attach an axle to a central portion of the leaf spring. The other end of the leaf spring is curved down and laterally inward so that the end of the leaf spring is positioned directly underneath the vehicle frame and the air spring may be connected directly between the leaf spring and frame.

### FIELD OF THE INVENTION

This invention relates generally to leaf spring suspension systems, and more particularly to leaf spring suspension systems having reduced weight and part count.

### BACKGROUND OF THE INVENTION

An automotive suspension system is designed to support a vehicle frame or body relative to a number of wheeled axles. The suspension system components work together to isolate the vehicle from the road so as to provide a soft, smooth ride for the vehicle occupants over an irregular road surface. The design of a suspension system seeks to balance the often conflicting goals of isolating the motion of the axle from the frame while providing desirable handling characteristics and minimizing manufacturing and operating costs.

A suspension system design often used in long-haul trucks includes a leaf spring, air spring, and shock absorber. Typically, each end of an axle is mounted near the center of a leaf spring which has a forward end mounted to the vehicle frame so that leaf spring may pivot in a vertical plane perpendicular to the road surface. An air spring connects the rear end of the leaf spring to the vehicle frame. A shock absorber is also coupled between the leaf spring or axle and the vehicle frame. Flexing of the leaf spring combined with the operation of the air spring and shock absorber isolate and dampen vertical motion of the wheels as they negotiate the roadway, thereby providing a smoother ride.

Although leaf spring, air spring, and shock absorber type suspension systems are successful, they tend to have a high number of component parts and are relatively heavy. The high number of parts contributes to high cost for manufacturing, assembly, inventory, and maintenance of the suspension system. A heavy suspension system reduces fuel economy and may also reduce useful load on roadways having axle weight limits. Thus, reducing suspension system weight is desirable.

However, a suspension system must also be strong and durable. For example, a typical heavy duty truck may be driven an average of 100,000 miles per year, or more, and may be driven well over a million miles in its useful lifetime. Thus, suspension system components may have design lifetimes of up to 1.5 million miles.

It would therefore be desirable to provide a leaf-air spring suspension system having fewer parts and a lower system weight without sacrificing system durability.

It would also be desirable to provide a low-weight suspension system suitable for use in long-haul trucks and other vehicles.

### SUMMARY OF THE INVENTION

An object of the present invention is to provide a suspension system having fewer parts and lower weight than previously known suspension systems.

These and other objects of the invention are achieved by a leaf spring-air spring suspension system. A forward end of the leaf spring has a formed eye pivotally mounted to a lightweight bracket connected to the vehicle frame. The leaf spring is shaped so that the rearward portion of the leaf spring is positioned underneath the vehicle frame so that an air spring may be connected between the leaf spring and frame without using a cross beam.

### BRIEF DESCRIPTION OF THE FIGURES

The above objects and advantages of the present invention will be readily apparent upon consideration of the accompanying detailed description taken in conjunction with the accompanying drawings in which like characters refer to like parts throughout and in which:

FIG. 1 is an oblique view of a leaf-air suspension system in accordance with the principles of the present invention;

FIGS. 2A and 2B are an oblique top and bottom views of one embodiment of the leaf spring of FIG. 1;

FIG. 3 is an oblique view showing the pivot pin and frame bracket of FIG. 1 in more detail;

FIG. 4 is an oblique view of the upper axle clamp of FIG. 1;

FIG. 5 is an oblique view of a lower axle clamp;

FIGS. 6A and 6B are oblique views of alternative lower axle clamps; and

FIGS. 7A and 7B are oblique views of a shock absorber and air lift control valve.

### DETAILED DESCRIPTION OF THE INVENTION

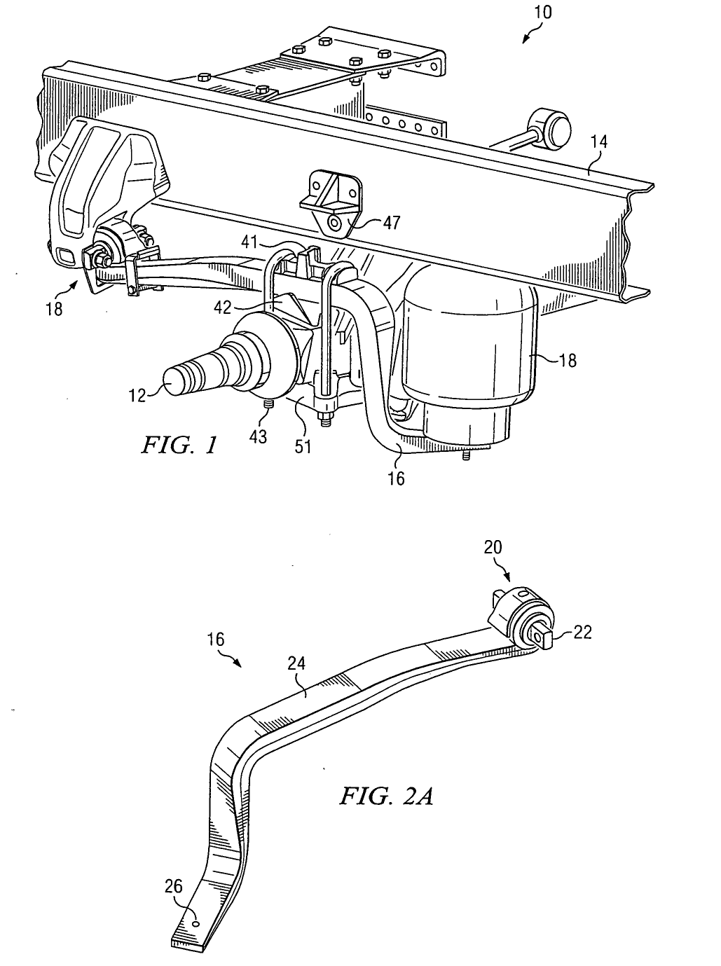

The present invention relates to suspensions systems having a reduced part count and a reduced system weight. Although the suspension of FIG. 1 is shown mounted to the left hand longitudinal beam of a heavy duty, large payload wheeled vehicle frame, such as for a long haul truck, the disclosed suspension system may be advantageously used in other devices or systems using leaf spring suspensions. More over, although only the left hand side of a single axle is shown in the figures, one skilled in the art will understand that a similar suspension system is provided to support the right hand side of an axle, and that a vehicle may be supported by multiple axles each having a similar suspension system.

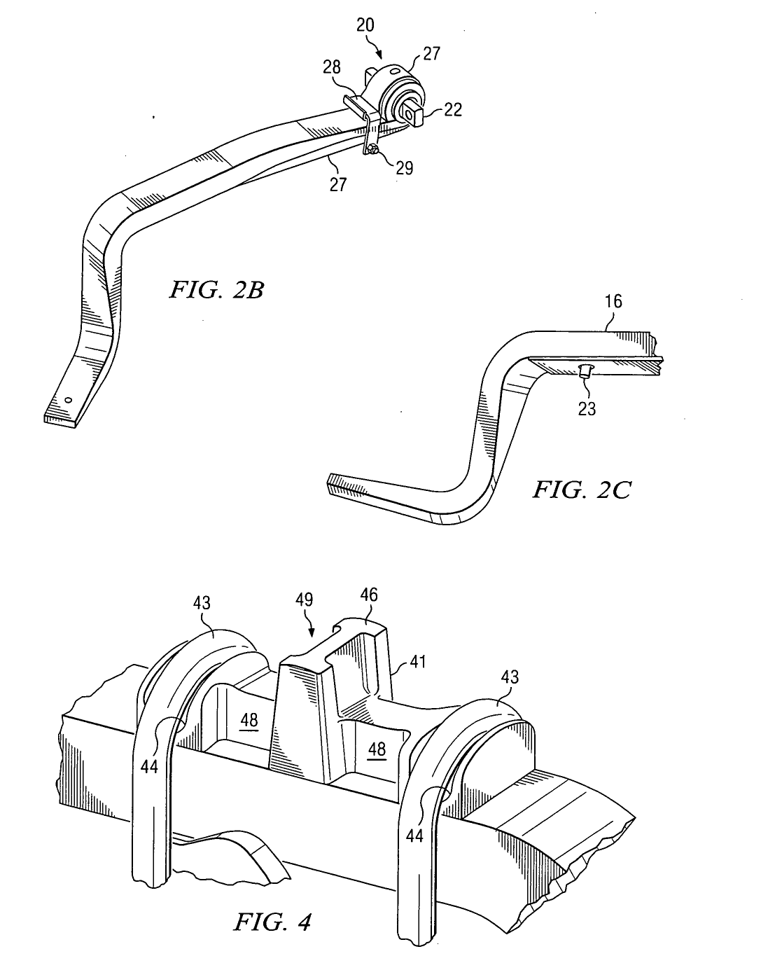

As shown in FIG. 1, suspension system 10 includes axle 12 disposed beneath and substantially perpendicular to frame 14. The relative position of axle 12 with respect to frame 14 is maintained by operation of leaf spring 16 and air spring 18 as described herein below. As shown in FIG. 2A, leaf spring 16 preferably tapers towards each end to reduce weight. Leaf spring 16 has eye 20 formed in the forward end thereof to accept bar pin assembly 22. A relatively flat central portion of leaf spring 16 provides axle mounting area 24 for mounting axle 12 to leaf spring 16. To provide a lower ride height, a portion of leaf spring 16 curves downward to accommodate the height of air spring 18. The rearward portion of leaf spring 16 curves laterally inward toward frame 14 so that the end of the spring is positioned beneath frame 14. This allows air spring 18 to be coupled between leaf spring 14 and frame 16 without requiring additional cross members thereby reducing suspension system weight. Note that leaf springs on opposite sides of the vehicle are mirror images of one another.

Leaf spring 16 is subject to large static forces due to the weight of the vehicle and any load being carried. Leaf spring 16 is further subjected to large bending and tensile loads due to relative motions between vehicle frame 14 and axle 12 as the vehicle is driven. For instance, as a vehicle is driven over a roadway bumps and potholes in the road surface, the center of leaf spring 16 is deflected vertically relative to frame 14. This deflection results in a bending force being applied to leaf spring 16 and causes leaf spring 16 to flex along its length. Vehicle acceleration and breaking cause forces generally parallel to the vehicle frame to be applied to leaf spring 16, thereby subjecting leaf spring 16 to tensile and compressive loads. Accordingly, leaf spring 16 as well as the other component parts of suspension system 12 must be sufficiently strong and durable to withstand these forces over a significant length of time.

The high forces applied to leaf spring 16 may result in failure of the spring during use. Such failure may result in uncontrolled motion of axle 12 relative to frame 14. For example, a complete separation of leaf spring 16 between eye 20 and axle attachment area 24 may result in forward or rearward motion of one end of axle 12 relative to frame 14 so that axle 12 twists beneath the vehicle. Such a failure may result in a loss of control of a vehicle and has the potential to cause significant damage. To guard against such catastrophic failures, leaf spring 16 preferably comprises multiple layered components.

In one embodiment of leaf spring 16, leaf spring 16 comprises two spring leafs disposed one on the other as shown in FIG. 2A. At the forward end the formed eye of one spring leaf is wrapped around the formed eye of the other spring leaf. A pin and recess, a through bolt, or some other mechanism is provided in the axle attachment area to maintain the alignment between the two spring leafs. Both spring leafs may have similar lengths so that the entire leaf spring from eye 20 to air spring mounting point 26 comprises two spring leafs. Alternatively, one spring leaf may be shorter that the other so that only the portion from eye 20 to axle attachment area 24 comprises two spring leafs. In either design, the leaf springs are designed so that in the event one spring leaf fails, the other spring leaf is sufficient to prevent catastrophic failure of the suspension system.

In a second embodiment of the invention, leaf spring 16 comprises a single spring leaf with a safety strap disposed along a portion thereof. For example, as shown in FIG. 2B, safety strap 27 is wrapped around eye 20 and disposed along a lower surface of leaf spring 16. Clip 28 and pin 29 hold safety strap 27 in place around eye 20, whereas a tail portion of safety strap 27 includes a hole or opening that fits over alignment pin 23 protruding from the bottom surface of spring leaf 16 as shown in FIG. 2C.

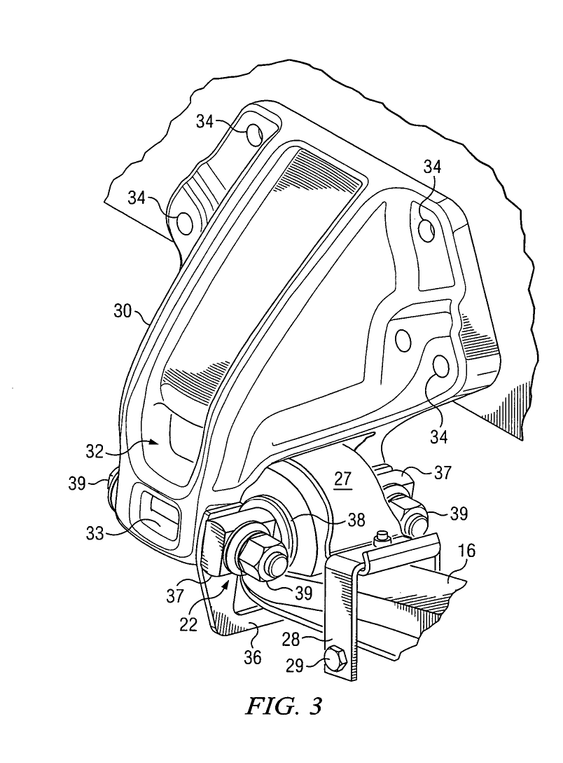

The forward end of leaf spring 16 is pivotally coupled to frame 14 by means of bar pin assembly 22 which is mounted to a frame bracket. This is shown in more detail in FIG. 3. Frame bracket 30 is formed from a lightweight metal or other material of sufficient strength and durability. Preferably, frame bracket 30 comprises an aluminum bracket designed using Finite Element Analysis techniques to provide reduced weight while maintaining the necessary strength and durability characteristics. For example, frame bracket 30 may include recesses and openings such as recess 32 and opening 33 to reduce the amount of material in bracket 30 and thereby minimize weight and material cost of the bracket. Frame bracket 30 includes holes 34 for securely mounting frame bracket 30 to vehicle frame 14 using bolts (not shown) or other suitable fastening methods.

Frame bracket 30 has a transverse portion defining a surface substantially perpendicular to frame 14. Bolt holes are provided in the transverse surface of bracket 18 for accepting bolts for attaching of bar pin assembly 22. Bracket 30 is preferably configured so that when mounted to frame 14, bar pin assembly 22 is substantially orthogonal to a face of frame 16 and parallel to the road surface. Preferably bracket 30 is symmetrical so that a single bracket design may be used for mounting a suspension on either the right or left side of the vehicle.

Bar pin assembly 22 functions as a pivot point or axis about which leaf spring 16 rotates. Bus pin assembly 22 generally comprises bar 37 having a generally round central cross section designed to fit eye 20 in leaf spring 16. Bushing 38 is disposed on bar 37 to reduce wear between eye 20 and bar 37. Preferably, bushing 38 also includes a solid lubricant to reduce friction between eye 20 and bar 37. For example, Delrin may be suitable for use as bushing 38. The ends of bar 37 are flattened and have bolt holes formed therein corresponding to the bolt holes in frame bracket 30. Bolts 38 securely attach bar pin assembly 22 to frame bracket 30. Wear washers 38 are provided on bar pin assembly 22 to prevent wear between a eye 20 and frame bracket 30.

Advantageously, the arrangement of bracket 30 and bar pin 22 provides a convenient means for truing the alignment of axle 12 to frame 16 by the insertion or removal of shims 36 between bracket 30 and bar pin 22. For example, removing shims 36 from between bracket 18 and bar pin 22 on the right side of a vehicle and and/or inserting shims 36 between bracket 18 and bar pin 22 on the left side of the vehicle twists the axle in a clockwise direction relative to frame 14 when viewed from above. Conversely, inserting shims 36 between bracket 18 and bar pin 22 on the right side of a vehicle and and/or removing shims 36 from between bracket 18 and bar pin 22 on the left side of the vehicle twists the axle in a counterclockwise direction relative to frame 14 when viewed from above.

Axle 12 is mounted to central portion 24 of leaf spring 16 using, for example, u-bolts and suitably shaped brackets, saddles, and clamps. Referring now to FIGS. 4-6, axle 12 and leaf spring 16 are juxtaposed between upper saddle 41, axle seat 42, and lower saddle 51, which are clamped together by u-bolts 43. The position of axle 12 relative to leaf spring 14 is determined by locating pin 23 on the underside of leaf spring 16 as shown in FIG. 2C. Pin 23 mates with a corresponding hole or recess in the top surface of axle seat 42. Saddle 41 is positioned on top of leaf spring 16. In a preferred embodiment of the present invention, axle seat 42 and saddle 41 are made of a ductile material, such as ductile iron, to provide light weight and suitable strength and durability. The lower surface of saddle 41 is relatively flat to provide a large contact area with leaf spring 16. The upper surface of saddle 41 includes troughs 44 that that are configured to fit U-bolts 43. Recessed portions 48 and 49 minimize the weight and material used to manufacture saddle 41 while maintaining sufficient cross section under u-bolts 43.

Preferably, saddle 41 also includes a integrate travel stop 46 that extends vertically above the uppermost extent of u-bolts 43. When the suspension system is compressed to an extreme degree, due to driving over a large bump at high speed for instance, travel stop 46 may come into contact with travel limit 47 disposed from frame 14 as shown in FIG. 1. Contact between travel stop 46 and travel limit 47 prevents further compression of the suspension system and may prevent damage to suspension system and drive train components.

Axle seat 42 fits between leaf spring 16 and axle 12 (see FIG. 1) to prevent relative motion between the two. For example, axle seat 42 may include lips or ridges the project upwardly on either side of leaf spring 16 to prevent lateral motion of leaf spring 16. Similarly, axle seat 42 may also include forward and aft projections to capture axle 12 and prevent for an aft motion of the axle relative to axle seat 42.

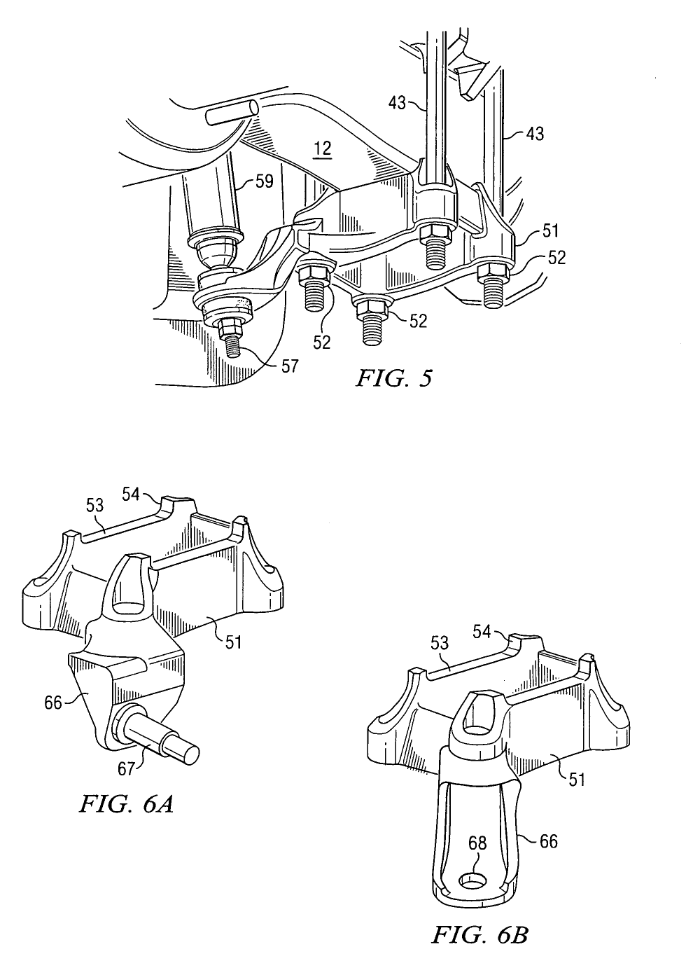

Lower axle clamp 51 is disposed beneath axle 12 and accepts the legs of U-bolts 43 as shown in FIG. 5. Two-piece nuts 52 on u-bolts 43 provide the tension needed to clamp axle 12 and leaf spring 14 between lower axle clamp 51 and upper saddle 41 and thereby rigidly couple axle 12 and leaf spring 14 together. Lower axle clamp includes an upper surface 53 adapted to mate with a lower surface of axle 12 as shown in FIGS. 6A and 6B. For example, lower axle clamp 51 includes large, relatively flat areas 53 that abut the bottom surface of axle 12, and raised side portions 54 that prevent lateral movement between axle 12 and lower axle clamp 51. Lower axle claim 51 is preferably made of ductile iron, or similar material.

In a preferred embodiment of the present invention, lower axle clamp 51 further includes a bracket for mounting a lower end of a shock absorber or other dampening device. Lower shock bracket 66 is disposed from a side or corner of lower axle clamp 51 and is adapted to accept an end of a shock absorber or similar device. In one embodiment of the invention, lower shock bracket 66 includes machined stud 67 which is press fit into a corresponding recess in lower shock bracket 66. Bracket 66 is configured so that stud 67 is disposed at an angle suitable for mating to a corresponding lower eye in shock absorber 59. Alternatively, lower shock bracket 58 may include a hole 68 or recess for accepting shock absorber 59 of the type having stud 57 in the end thereof as shown in FIG. 6B.

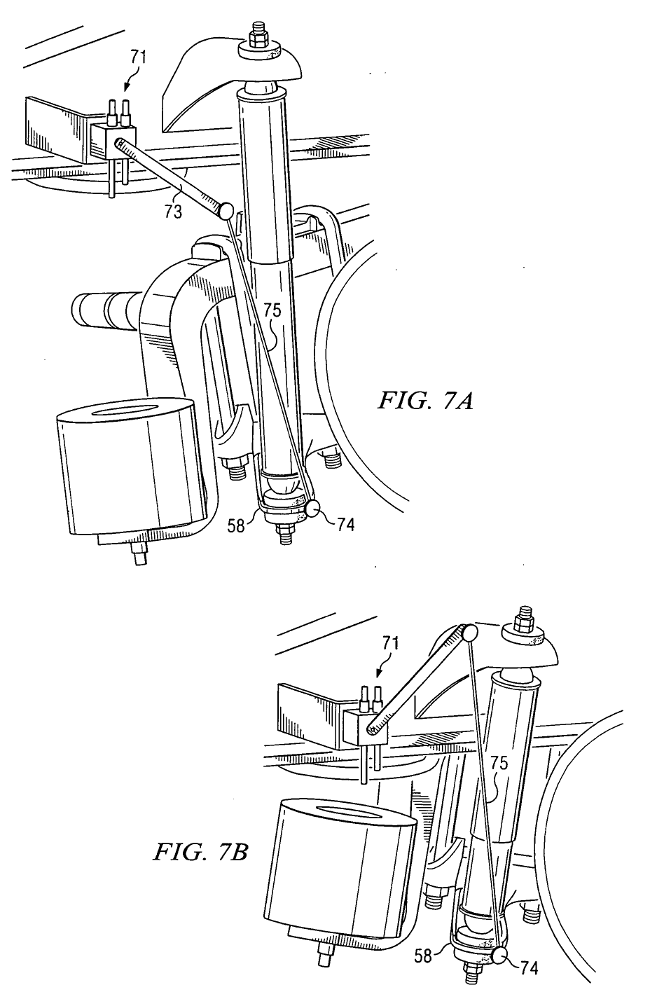

The rearmost end of leaf spring 16 is coupled to frame 14 by air spring 18. When the vehicle is loaded, air spring 18 compresses and leaf spring 16 pivots on bar pin assembly 22 allowing axle 12 to move vertically relative to frame 14. Leaf spring 16 may also flex somewhat. The air pressure in air spring 18 may be altered to adjust the position of leaf spring 16 relative to frame 14, and thereby adjust the ride height of the vehicle and maintain adequate travel clearance for axle 12. Preferably, the ride height adjustment is made automatically by a multi-way air valve suitably linked to the vehicle frame and axle. For example, as shown in FIG. 7, height control valve 71 is mounted to frame 14 near shock absorber 59. Arm 73 on height control valve 71 is connected to stud 74 disposed from lower shock bracket 58 by linkage 75. A source of high pressure air (not shown) is coupled to valve 71 and various air reservoirs (not shown) are connected air spring 18 as is known in the art.

During normal driving, suspension system 10 compresses and extends within a normal operating range. When a vehicle is loaded, or encounters a large bump, suspension system 10 may be compressed beyond this normal operating range. When this happens, arm 74 and linkage 75 cause air valve 71 to operate to admit high pressure air to air-spring 18. This increases the downward force on the end of leaf spring 16 provided by air-spring 18, thereby opposing further compression of the suspension system. Conversely, when a vehicle is unloaded, suspension system 10 may become extended beyond its normal operating range. In this event, linkage 75 and arm 74 cause air valve 71 to vent high pressure air from air spring 18, thereby reducing the force on the end of leaf spring 16. Preferably, height control valve 71, arm 73, stud 75, and linkage 75 are configured so that when suspension system 10 is fully extended an angle between arm 74 and linkage 75 is less than about 150 degrees, and during full compression of suspension system 10, arm 74 and linkage 75 remain below the extended taper.

The present invention is not limited to the specific examples described and typical variations within the ordinary skill in the are also considered to be within the scope of the present invention. Although the present invention has been fully described by way of examples with reference to the accompanying drawings, it is to be noted that various changes and modifications will be apparent to those skilled in the art. Therefore, such changes and modifications should be construed as being within the scope of the invention.

What is claimed is:

1. A suspension for a heavy duty vehicle, the suspension comprising:
a leaf spring comprising:
an eye formed at a first end of the leaf spring;
an axle attachment area;
a downward bend adjacent to the axle attachment area; and
a second end displaced laterally relative to the plane of the leaf spring;
a frame bracket disposed from a frame of the vehicle;
a bar pin disposed in the eye and coupled to the frame bracket, wherein the second end of the leaf spring is positioned opposite the frame; and
an air spring coupled between the frame and the second end of the leaf spring.

2. The suspension of claim 1 further comprising:
an upper axle clamp disposed below an axle;
a axle seat disposed between the axle and the leaf spring;
a lower axle clamp disposed above the leaf spring; and
a clamp for clamping the lower axle clamp, axle, axle seat, leaf spring, and upper axle clamp together.

3. The suspension of claim 2, wherein the upper axle clamp, axle seat, and lower axle clamp comprise a ductile material.

4. The suspension of claim 3, wherein the ductile material is a ductile iron.

5. The suspension of claim 1, further comprising a bumper disposed from the frame, wherein the upper axle clamp further comprises an upward projecting portion adapted to contact the bumper to limit vertical travel of the axle.

6. The suspension of claim 1, further comprising:
a level adjust valve disposed from the frame, the level adjust valve coupled to a source of pressurized air and adapted to provide the pressurized air to the air spring or to vent pressurized air from the air spring; and
a linkage coupled between the lower axle clamp and the level adjust valve so as to actuate the valve responsive to a position of the axle relative to the frame.

7. The suspension of claim 6, wherein the lower axle clamp further comprises a projection for coupling the control linkage thereto.

8. The suspension of claim 1 further comprising a shock absorber, wherein the lower axle clamp further comprises a projecting portion adapted to couple to a first end of the shock absorber, and a second end of the shock absorber is coupled to the frame.

9. The suspension of claim 8, wherein the projecting portion comprises a stud press fit into a recess in the lower axle clamp, the stud adapted to mate with a corresponding eye in the lower end of the shock absorber.

10. The suspension of claim 8, wherein the projecting portion comprises a bracket having a hole therein adapted to accept a stud projecting from a lower end of the shock absorber.

11. The suspension of claim 1, further comprising a bushing disposed around the bar pin.

12. The suspension of claim 1, wherein the leaf spring comprises a pair of complimentarily shaped leaf springs disposed one on the other.

13. The suspension of claim 12, wherein the leaf springs are of approximately the same thickness.

14. The suspension of claim 12, wherein the leaf springs are of different thickness.

15. The suspension of claim 12, wherein each leaf spring comprises a material of sufficient strength to prevent longitudinal motion between the axle and frame in the even of a failure of one of the leaf springs.

16. The suspension of claim 1, wherein the leaf spring comprises multiple complimentarily shaped components disposed one on the other.

17. The suspension of claim 16, wherein the multiple components comprise material of sufficient strength to prevent longitudinal motion between the axle and frame in the even of a failure of one of the other components.

18. A heavy duty truck suspension for coupling an axle to a frame, the suspension comprising:
a frame bracket disposed from the frame;
a leaf spring having first and second ends, the first end including an eye for pivotally coupling the leaf spring to the frame bracket and the second end being disposed directly beneath the frame;
an air spring coupled between the frame and the second end of the leaf spring;
an upper axle clamp disposed above the leaf spring;
an axle seat disposed between the axle and the leaf spring;
a lower axle clamp disposed below the axle;
a clamp for clamping the lower axle clamp, axle, axle seat, leaf spring, and upper axle clamp together;
a shock absorber coupled between the lower axle clamp and the frame; and
a level adjust valve disposed from the frame and coupled to the lower axle clamp so that the valve is operated responsive to a position of the axle relative to the frame.

19. The suspension of claim 18, wherein the leaf spring comprises at least two components coupled between the frame bracket and the axle.

20. The suspension of claim 19, wherein the at least two components substantially prevent longitudinal motion of the axle relative to the frame in the event one of the at least two components fails.
